(19) United States
(12) Patent Application Publication
(10) Pub. No.: US 2003/0233377 A1
(43) Pub. Date: Dec. 18, 2003

(54) Methods, systems, software and apparatus for prediction of polygenic conditions

(76) Inventor: Ilija Kovac, Baltimore, MD (US)

Correspondence Address: ILIJA KOVAC Ph.D, 702 SOUTH POTOMAC STREET, BALTIMORE, MD, 21224, US

(21) Appl. No.: 10/459,933

(22) Filed: Jun. 12, 2003

Related U.S. Application Data
(60) Provisional application No. 60/389,206, filed on Jun. 18, 2002.

(51) Int. Cl. G06F 7/00

(52) U.S. Cl. 707/104.1

(57) ABSTRACT

The invention relates to methods, systems, software and apparatus for prediction of polygenic conditions or disorders, based on dynamical system theory. The methods of the invention include a comparison of allelic information from a test subject with that of an affected reference subject suffering from a condition or disorder, to yield a similarity measurement. The comparison may be repeated with each of a plurality of affected subjects to yield a plurality of similarity measurements. The plurality of similarity measurements is used to generate a reconstructing vector, from which a maximal similarity value is obtained, from which a probability value is derived which is used to predict whether the test subject will suffer from the condition. The invention thus provides improved genetic predictive methods which are useful in early identification of vulnerable individuals, counselling, prevention and treatment, and for the study of developmental biological complexity at the level of individual organism.

This utility patent application claims priority of the U.S. provisional patent application No. 60/389,206, filed on Jun. 18, 2002.

### FIELD OF THE INVENTION

The invention relates to the prediction of polygenic conditions.

### BACKGROUND OF THE INVENTION

With the exception of identical siblings, the genomic sequence from one individual to another varies significantly. Certain sequence variants may be associated with certain diseases. In some cases, susceptibility to a disease may result from a single genetic mutation in a classic Mendelian fashion(Mendel 1865). Other cases may be more complex, and in some cases susceptibility to a disease relates to the development of an individual organism (ontogenesis) and is due to polygenic (i.e. associated with multiple genes) factors, which may further involve environmental factors. Polygenic etiology is particularly evident in disorders that emerge at a high level of developmental organization, far removed from the sequence of any particular gene, including but not limited to psychiatric disorders which involve complexities of brain function (Schork 1997; McIntosh 1999; Cossart et al 2003).

In the discipline of genetic epidemiology, genes related to numerous, but largely Mendelian, disorders were successfully identified (Antonarakis and McKussick 2000). This is typically initiated by detecting statistical effects of particular genes in samples that contain plurality of individuals (Ott 1999). However, in polygenic disorders genetic susceptibility is presented by combinations of numerous sequence variants at various positions in the genome that are, due to rare frequency of any particular such polygenic combination, nearly unique to each individual. Accordingly, blending different individuals together to form a sample results in the loss of polygenic information at the hierarchical level of the individual.

Consequently, statistical genetics can more or less reliably indicate only a minute part of pertinent genetic information, i.e. particular genes with statistical effects that can be consistently replicated in at least some of different samples and can not be generalized to other individuals in the general population (Levinson et al 2002 DeLisi 2000; Craddock and Jones 1999; Schork and Schork 1998). Reliable statistical results can be further less likely for joint analyses of multiple loci, which provide more room for idiosyncratic influences of genetic and environmental architecture in the sample at hand (Suarez et al 1994). While such analyses can be feasible when few particular genes jointly account for most of genetic variation in the population, polygenic disorders exhibit above noted complexities beyond such a simple model. To date no genes are conclusively identified in relation to polygenic disorders. Because such disorder is not substantially determined by the function of any particular gene, the use of gene function is of limited use in the triage of statistical results. Moreover, most genetic variants that can be statistically implicated in polygenic disorders are likely to be frequent in the population (Lohmueller et al 2003), and so everyone in the population would carry such a genetic polymorphism very peripherally, and only sometimes, involved in a developmental, environmentally influenced polygenic disorder. In stark reversal from Mendelian disorders, it can be said that the number of genetic variants that can be statistically implicated in a polygenic disorder is limited principally by the number of samples that we form from the population, while predictive and medical utility of such genetic variants is comparatively much diminished. Examining statistical approaches to identification of particular genes in complex disease based on DNA sequence or expression, Weiss and Terwilliger (2000) conclude: “The problems faced in treating complex diseases as if they were Mendel's peas show, without invoking the term in its faddish sense, that ‘complexity’ is a subject that need its own operating framework, a new twenty-first rather than nineteenth- or even twentieth-century genetics”.

The best early predictor of a polygenic condition remains the presence of an affected close biological relative, based on empirical risk data collected for various degrees of relationship to the affected individual (Ott 1999). However, most of individuals who will become affected with a developmental polygenic condition do not have affected close biological relatives: for example, ˜90% of schizophrenic individuals do not have an affected parent, and ˜80% do not have affected parent or sibling (Gottesman and Shields 1984). Therefore, said predictor can not be applied to a large majority of individuals who will become affected with a developmental polygenic disorder.

Polygenic disorders are frequent in the population (˜1-15%), posing significant hardship to affected individuals, their families, and the society at large (Kessler et al. 1994). The cost to society is on the order of tens of billions of dollars per year (www.ncqa.org 2002). Prediction based on DNA information constitutes very early forewarning of potential disorder, allowing for better counseling, prevention, and treatment. It is therefore useful to develop novel methods that improve early prediction by capturing polygenic information at the level of the individual. The invention disclosed herein, presented in further detail below, involves disciplines of dynamical system theory and genetics to capture said polygenic information.

### RELEVENT ART IN DYNAMICAL SYSTEM THEORY

This subsection summarizes system science necessary to understand scientific basis of the invention detailed further below.

By definition, state of the dynamical system, hereafter referred to as system-state, changes over time. Many kinds of data in diverse scientific disciplines represent successive observations in time, known as time series, made on dynamical systems. The relationship between a dynamical system and observation x at a time t is generically defined by a read-out function f, which assigns a real number to the system-state S at each time of measurement t:

Xₜ=f(Sₜ) 1)

In many instances, complexity of the system rules out analytical modeling of processes that govern dynamics of system-state, thereby precluding Newtonian prediction of future observations from first principles. For an example, see the Couette-Taylor experiment, where analytical prediction can be intractable as it may require thousands of differential equations to model the flow of fluid in small regions (Alligood et al. 1997).

Dynamical system theory solves the problem of prediction without analytical knowledge by embedding one-dimensional data, observed on the system as a whole, into a higher-dimensional space of reconstructing vectors derived from past observations. More specifically, for each observation xₜ in the time series a reconstructing vector Xₜ can be generated, which is composed of past observations separated by some time delay T:

xₜ→Xₜ=[xₜ, x_{t-T}, x_{t-2T}, . . . x_{t-(m-1)T}] 2)

Reconstructing vector Xₜ is m-dimensional, and so m is referred to as an embedding dimension. Takens' reconstruction theorem proves that dynamical trajectory of reconstructing vectors alone contains enough information to reproduce dynamical trajectory of system-states found in the original, analytical state space (Takens 1981; see Alligood et al. 1997). As a relatively simple example, consider the Lorenz dynamical system (Lorenz 1963). Therein, the coordinates of the original, analytical state space are defined by variables x, y, and z. When plotted in such original coordinates (x, y, z), states of the Lorenz system form a dynamical trajectory called the Lorenz attractor. Said trajectory can be reconstructed from the time series of the x variable alone, without any whatsoever analytical knowledge of dynamics in the original analytical state space (x, y, z). This can be done by plotting reconstructing vectors Xₜ, i.e. plotting each observation of x in delay coordinates of the reconstructing vector using m=3 and T=0.1; the plot coordinates then become (xₜ, x_{t-0.1}, x_{t-0.2}), instead of original (x, y, z) (see Alligood et al. 1997). Thus, prediction is obtained from a measurement taken on the system as a whole, circumventing analytically inscrutable complexities within the system such as those in the Couette-Taylor experiment. The prediction is effected by method of analogues, i.e. by observing how the system evolved from that past system-state which is similar to present system-state (Alligood et al. 1997).

In summary, prediction in analytically inscrutable dynamical systems can be obtained by embedding one-dimensional data, observed on the system as a whole, into a higher-dimensional space of reconstructing vectors derived from past observations. This embedding procedure allows for prediction by method of analogues.

### SUMMARY OF THE INVENTION

The invention relates to methods, systems, software and apparatus for the prediction of a polygenic condition or disorder. The invention captures polygenic information at the level of the individual, thereby improving early prediction of polygenic conditions at the level of the individual.

The invention relates to the comparison of allelic information from a “test” subject, of unknown risk status for a given condition or disorder, with allelic information of an affected “reference” subject known to suffer from the condition or disorder. Such a comparison yields a similarity measurement. A plurality of such one-to-one comparisons between the same test subject with each of a plurality of different reference subjects yields a plurality of such similarity measurements. As outlined in mathematical detail below, such a plurality of similarity measurements is used to generate a reconstructing vector, which in turn allows the derivation of a maximal similarity value for a given vector. This maximal value is used to determine a probability value used to predict the probability that the test subject shall suffer from the condition or disorder. Because reconstructing vector is generated from one-to-one comparison of individuals, the method captures polygenic information at the level of the individual, as distinct from traditional statistical effects of particular genes in samples that blend multiple individuals. The invention is thus useful in improving prediction of polygenic conditions at the level of the individual.

According to a first aspect of the present invention, there is provided an apparatus for predicting the probability that a test subject develops a condition, said apparatus comprising:

a) an input for receiving test data containing allelic information derived from the test subject;

b) a database containing a plurality of reference data blocks, each data block containing allelic information derived from a reference subject suffering from the condition;

c) a processing unit for:

i) comparing the test data with a plurality reference data blocks to derive respective similarity measurements;

ii) deriving a predictive probability value from the similarity measurements;

d) an output to release data containing the predictive probability value.

According to a further aspect of the present invention, there is provided a method for predicting the probability that a test subject develops a condition, said method comprising:

a) providing test data containing allelic information derived from the test subject;

b) providing a database containing a plurality of reference data blocks, each data block containing allelic information derived from a reference subject suffering from the condition;

c) comparing the test data with each reference data block to derive a plurality of respective similarity measurements; and

d) deriving a predictive probability value from the similarity measurements;

wherein the predictive probability value is used for predicting the probability that a test subject develops the disorder.

According to a further aspect of the present invention, there is provided a computer-readable media tangibly embodying a program of instructions executable by a computer to perform a method for predicting the probability that a test subject develops a condition, the method comprising:

a) providing test data containing allelic information derived from the test subject;

b) providing a database containing a plurality of reference data blocks, each data block containing allelic information derived from a reference subject suffering from the condition;

c) comparing the test data with each reference data block to derive a plurality of respective similarity measurements; and

d) deriving a predictive probability value from the similarity measurements;

wherein the predictive probability value is used for predicting the probability that a test subject develops the condition.

According to a further aspect of the present invention, there is provided an apparatus for predicting the probability that a test subject develops a condition, said apparatus comprising:

a) an input for receiving a plurality of similarity measurements, wherein said similarity measurements are obtained by respective comparisons of a test genomic sequence from a test subject with each of a plurality of reference genomic sequences from a respective plurality of reference subjects suffering from the condition, by a comparison method comprising physico-chemical reactions between said test and reference genomic sequences;

b) a processing unit for deriving a predictive probability value from the similarity measurements; and

c) an output to release data containing the predictive probability value.

According to a further aspect of the present invention, there is provided a method for predicting the probability that a test subject develops a condition, said method comprising:

a) comparing a test genomic sequence from a test subject with each of a plurality of reference genomic sequences from a respective plurality of reference subjects suffering from the condition, by a comparison method comprising physico -chemical reactions between said test and reference genomic sequences, to obtain a plurality of respective similarity measurements;

b) deriving a predictive probability value from the similarity measurements;

wherein the predictive probability value is used for predicting the probability that a test subject develops the condition.

According to a further aspect of the present invention, there is provided a computer-readable media tangibly embodying a program of instructions executable by a computer to perform a method for predicting the probability that a test subject develops a condition, the method comprising:

a) comparing a test genomic sequence from a test subject with each of a plurality of reference genomic sequences from a respective plurality of reference subjects suffering from the condition, by a comparison method comprising physico -chemical reactions between said test and reference genomic sequences, to obtain a plurality of respective similarity measurements;

b) deriving a predictive probability value from the similarity measurements;

wherein the predictive probability value is used for predicting the probability that a test subject develops the condition.

In an embodiment, the comparison method is Genomic Mismatch Scanning.

In an embodiment, the genomic sequence is derived from an entire genome. In an embodiment, genomic sequence is derived from a subset of a genome. In an embodiment, genomic sequence is obtained from a part of the test subject and the reference subject, including but not limited to a tissue, cell type, and/or organ.

In an embodiment, the allelic information comprises single nucleotide polymorphisms (SNPs).

In an embodiment, the allelic information is obtained from an entire genome.

In an embodiment, the allelic information is derived from a subset of a genome.

In an embodiment, the allelic information is obtained by a genotyping method based on a technique selected from the group consisting of:

a) nucleotide sequencing;

b) minisatellite marker analysis;

c) microsatellite marker analysis;

d) hybridization of allele-specific probes;

e) restriction fragment length polymorphism (RFLP) analysis; and

f) any combination of (a) to (e).

In an embodiment, the allelic information is obtained from a nucleic acid molecule selected from the group consisting of DNA and RNA.

In an embodiment, the DNA is selected from the group consisting of genomic DNA and cDNA.

In an embodiment, the nucleic acid molecule is amplified prior to its use as a source to obtain allelic information.

In an embodiment, the allelic information comprises gene expression data. In a further embodiment, the allelic information is obtained from protein structure and/or function information.

In an embodiment, the allelic information is obtained from a part of the test subject and the reference subject. In embodiments the part of the test subject and the reference subject is selected from the group including a tissue, cell, or organ.

### BRIEF DESCRIPTION OF THE DRAWINGS

FIG. 1 is a block diagram of a software implemented apparatus according to a non-limiting example of implementation of the invention;

FIG. 2 is a graph obtained from an approximated example of a Genomic Reconstructing Function as applied to Schizophrenia. The plot represents Genomic Reconstructing Function P(xₙ/Gₙ)=f [maxΩ_{G}(Xₙ) ];

In the drawings, embodiments of the invention are illustrated by way of example. It is to be expressly understood that the description and drawings are only for purposes of illustration and as an aid to understanding, and are not intended to be a definition of the limits of the invention.

### DETAILED DESCRIPTION

The invention, presented in further detail below, relates to prediction of polygenic conditions or disorders.

I demonstrate herein that for each individual genome of unknown risk status (e.g. of a test subject), a reconstructing vector can be derived whose numerical values quantify Genomic Functional Similarity Ω_{G} with each of the genomes from a database of affected individuals (e.g. reference subjects), referred to as a Template Database. The Ω_{G} between any two individual genomes is defined as proportion of functional alleles of polymorphic sequences that are identical by state. This rationale behind a reconstructing vector is that Ω_{G}, while on the average greater between relatives, can nevertheless be substantial for a single pair of unrelated individuals. Based on empirical risks to relatives as initial quantitative benchmarks, a Genomic Reconstructing Function, which relates maximal Ω_{G} value from the reconstructing vector to the risk of disorder, is presented in an example of a polygenic condition (e.g. schizophrenia). Genomic Reconstructing Function Ω_{G} can be restricted to a certain subset of a genome, including but not limited to an organ, tissue, cell, functionally related network. Because reconstructing vector is generated from one-to-one comparison of individuals, the method captures polygenic information at the level of the individual, as distinct from traditional statistical effects of particular genes in samples that blend multiple individuals. The invention is thus useful in improving prediction of polygenic conditions at the level of the individual.

The invention thus relates to methods, systems, software and apparatus for the prediction of a polygenic condition or disorder. In an embodiment, such prediction is based on the comparison of allelic information (e.g. genomic sequence) from a “test” subject (of unknown risk status; for whom the prediction is being made) with allelic information from an affected “reference” subject who is known to suffer from the condition or disorder. Allelic information from a test subject may constitute “test data”; allelic information from a reference subject may constitute “reference data”. Such reference data may be contained in a corresponding “reference data block”. Such a comparison of allelic information between a test subject and a reference subject will yield a similarity measurement. When allelic information is available from a plurality of reference subjects (which may constitute a plurality of corresponding “reference data blocks” which in turn may be contained in a database, referred to for example as a “template” database), a plurality of corresponding similarity measurements can be determined. The plurality of similarity measurements may be used to generate a reconstructing vector, which in turn allows the generation of a probability value which enables a prediction to be made as to whether the test subject will be susceptible to the condition or disorder, the mathematical basis of which is described in the Examples section below.

“Condition” as used herein refers to any trait manifestation which has a genetic basis, for example a type of medical condition or disorder, e.g. illness and disease. A polygenic condition or disorder refers to a condition or disorder which is caused by and/or is associated with and/or correlates with events or alterations, such as allelic variation, at more than one position in the genomic sequence.

“Genome” is a summary term for the totality of genetic material in an individual organism, including genes as well as parts of DNA sequence which do not contain genes.

A “phenotype” is an observed trait. It could be anything that is observed, for example the measurement of enzyme activity, or an IQ coefficient, or a certain disorder.

“Ontogenesis”, or ontogenetic process, is a development of the individual organism from the fertilized egg at conception, taken here to conclude with the death of the individual organism.

Genomic sequences vary significantly and to different degrees between individuals (with the exception of identical or monozygotic (MZ) siblings). Such variance is due to sites or regions of the genome which are altered from one individual to another. Such alterations include among others insertions, deletions and substitutions and combinations thereof in the genomic sequence. When a certain genomic site or region is altered as such, different variants or forms of the site or region exist in different individuals. Such variants are referred to as alleles. Certain sites or regions are polymorphic and as such may exist in different forms or alleles. Other sites/regions are monomorphic and thus do not differ from one individual to another (i.e. do not exist in multiple alleles). Genomic sequences can show allelic polymorphisms in regions which encode gene products (coding sequences) as well as in regions which do not encode gene products.

In embodiments, differences between alleles may comprise one or more single nucleotide polymorphisms (SNPs). A SNP is a single base pair within a region of a nucleic acid (e.g. DNA) sequence wherein the identities of the nucleotides within the pair vary from one subject to another. Possible methods for identifying SNPs are described in for example WO95/12607; Botstein et al (1980); etc.

“Individual” as used herein when referring to for example genomic or allelic differences between “individuals”, refers to any single organism or being. In an embodiment, the individual is a mammal, in a further embodiment, a single human organism. In further embodiments, this term also refers to any of a number of model organisms commonly used in the laboratory, including but not limited to bacteria (e.g. E. coli), fungi (e.g. S. cerevisiae; S. pombe), D. melanogaster, C. elegans, plants (e.g. A. thaliana), mouse, rat, rabbit, zebra fish, etc.

The term “allelic state” refers to the nature of a particular allele at a given site. For example, a particular site may exist in two alleles, one allele being defined by the presence of guanine nucleotide and the other allele being defined by a cytosine nucleotide at the same site. Individuals possessing a guanine nucleotide at this particular site are said to possess the same allelic state with respect to this particular site, i.e. such individuals share alleles identical by state at this particular site. Those individuals that possess a guanine nucleotide at this particular site are said to possess a different allelic state when compared to those individuals who possess a cytosine nucleotide at this particular site.

“Allelic information” comprises any type of information which allows the distinction or differentiation of one allele from a different allele. This includes any information or representation which provides a description of a structural feature(s) of an allele. In embodiments, such information comprises nucleic acid sequence information. In embodiments, such nucleic acid sequence information may be obtained from nucleic acids such as DNA (e.g. genomic DNA or cDNA [derived from RNA]) and/or RNA. The nucleic acids may be modified for example to facilitate their detection.

“Functional” allelic differences refer to those allelic differences which result in some change (qualitative and/or quantitative) in phenotype of the organism, i.e. resulting in some degree of altered function. For example, functional allelic differences may comprise allelic differences which result in amino acid differences in a protein or an altered level of protein expression. However, a nucleotide change in a coding sequence which does not result in a corresponding amino acid change (i.e. a “silent” mutation due to redundancy of the genetic code) would typically not be considered a “functional” allelic difference as the difference would typically not be manifested in the phenotype of an organism.

In certain cases, allelic differences may be manifested at the protein level. For example, an alteration or polymorphism in a coding sequence may result in an amino acid alteration in a corresponding encoded protein (if the polymorphism is not silent). Such differences may result in a protein of altered structure and/or function. Therefore, in further embodiments, allelic information may comprise information with regard to protein structure and/or function.

In further cases, allelic differences, such as an alteration or polymorphism outside a coding sequence, may also result in alterations in gene expression. Therefore, in further embodiments, allelic information may comprise gene expression data. In an embodiment, such gene expression data is obtained via transcriptional profiling, in an embodiment, on a genomic scale (for example via microarray-based methods).

In embodiments, allelic information may be obtained from a subset or a portion of a genome. The subset or portion of a genome is prepared as such to provide sufficient allelic information for use in the method of the invention. In embodiments, such information may be obtained from a set of chromosomes, a single chromosome, a particular subchromosomal regional, or any portion of interest of the genome. Such a subset of the genome may for example be obtained and characterized as described in WO 00/18960 (published Apr. 6, 2000). In embodiments, such information may be obtained from a subset of a genome, which, for example, is associated with expression in a portion of the organism, including but not limited to a particular tissue, cell or organ. In further embodiments, such information may be obtained from a subset of a genome selected as being involved in a functionally related network. For example, sequences may be selected which are expressed in neural tissue (e.g. brain or functional networks within the brain). Such embodiments may for example have particular utility in the prediction of polygenic neural disorders.

In embodiments, methods of obtaining such allelic information may involve prior amplification of a nucleic acid region. In embodiments, such amplification may be done in a specific or random manner. In an embodiment, such amplification is performed by polymerase chain reaction (PCR) type methods (see Sambrook et al. 1989; Sambrook and Russell, 2001).

Allelic information may be obtained by any number of methods for the detection of DNA mutations which are routine and well known in the art. In embodiments such methods include a number of genotyping methods known in the art. Examples of such methods include, but are not limited to direct nucleic acid sequencing of the relevant regions (e.g. using the dideoxy chain termination method [see e.g., Sambrook et al, 1989; Sambrook and Russell, 2001) Restriction Fragment Length Polymorphism (RFLP) analysis (see Botstein et al., 1980; Nakamura et al., 1987), Microsatellite or minisatellite marker analysis (via the analysis of markers referred to as variable number of tandem repeats [VNTRs]), or the Oligonucleotide Ligation Assay (see Nickerson et al., 1990). Other methods may utilize hybridization of allele-specific probes under hybridization conditions which allow the detection of allelic differences. Microarray based methods may also be used, such as for example as described in U.S. Pat. Nos. 5,858,659 (Sapolsky et al.; Jan. 12, 1999) or 6,223,127 (Berno; Apr. 24, 2001). Microarray methods may in embodiments include arrays utilizing chip-, glass slide- and filter-type solid supports. The above genotyping methods may utilize a number of detection methods including but not limited to methods based on radioactivity and fluorescence or other changes in spectral properties.

In embodiments, allelic information from the test subject and the reference subject(s) may be compared by a physico-chemical reaction between genomes, such as Genomic Mismatch Scanning type-methods (Brown 1994). Genomic Mismatch Scanning involves denaturation and hybridization of two individual genomes under defined chemical conditions, such that genomic sequences that are identical between individuals can be identified. An example protocol includes: digestion of genomes with restriction enzymes, mixing, denaturation and hybridization; elimination of homohybrid (strands of the same genome) and purification of heterohybrid molecules using differential restriction methylase treatment and endonuclease digestion; elimination of heteroduplexes that contain base mismatches with a set of mismatch-repair enzymes; labeling and hybridizing of mismatch-free heterohybrids (identity by descent) to an ordered array of DNA samples representing genetic map; identification of identical regions by hybridization signal at the corresponding array elements (Brown 1994). The current effort on identifying regions identical by descent between relatives, for the purpose of traditional sample-based correlation of particular genes to traits, may be redirected to identifying identity by state data for use in the method of present invention. Such redirection may be towards incorporating analysis of heterohybrids that are less perfectly matched than regions of identity by descent.

In embodiments allelic information may be derived from markers which are genetically linked to a certain polymorphism. Such linkage refers generally to the probability of co-segregation of the marker with the polymorphism during genetic recombination.

Once allelic information is provided for a subject, in an embodiment, a plurality of subjects, suffering from a condition (i.e. affected or “reference” subject[s]) and an unaffected “test” subject, a comparison will be made between allelic information of an affected subject and that of the test subject, to generate a similarity measurement. Repeating the comparison for each of a plurality of affected or “reference” subjects with the same test subject yields a plurality of similarity measurements. Such measurements will be based on data indicating whether the affected subject and the test subject possess an identical allelic state for any particular allele at any particular position of interest in the genomic sequence. A higher proportion of identical allelic states across multiple positions of interest in the genomic sequence shall result in a higher overall similarity measurement between any given affected subject and test subject. A maximal similarity value is obtained from the reconstructing vector generated using plurality of similarity measurements, and this maximal similarity value relates to the probability that the test subject will suffer from the condition or disorder. A higher similarity value predicts a greater probability in this regard.

In embodiments, said similarity measurement may be inferred from data involving sequences for which functional attributes may be absent or unknown. With regard to sequence data, such inferred similarity measurements may for example be obtained by Genomic Mismatch Scanning type-methods, or optimal alignment of sequences for comparisons of similarity using a variety of algorithms, such as the local homology algorithm of Smith and Waterman (1981), the homology alignment algorithm of Needleman and Wunsch (1970), the search for similarity method of Pearson and Lipman (1988), and the computerized implementations of these algorithms (such as GAP, BESTFIT, FASTA and TFASTA in the Wisconsin Genetics Software Package, Genetics Computer Group, Madison, Wis., U.S.A.). Sequence similarity may also be determined using the BLAST algorithm, described in Altschul et al. (1990; using the published default settings). Software and instructions for performing BLAST analysis may be available through the National Center for Biotechnology Information in the United States (including the programs BLASTP, BLASTN, BLASTX, TBLASTN and TBLASTX that may be available through the internet at http://www.ncbi.nlm.nih.gov/). One measure of the statistical similarity between two sequences using the BLAST algorithm is the smallest sum probability (P(N)), which provides an indication of the probability by which a match between two nucleotide or amino acid sequences would occur by chance. Alternatively, nucleotide sequences are considered substantially identical if the smallest sum probability in a comparison of the test sequences is less than about 1, preferably less than about 0.1, more preferably less than about 0.01, and most preferably less than about 0.001. In the PSI BLAST implementation of the BLAST algorithm, an expect value for inclusion in PSI-BLAST iteration may be 0.001 (Altschul et al., 1997). Searching parameters may be varied to obtain potentially homologous sequences from database searches.

The methods of the invention relate to the prediction of whether an individual of unknown risk status will develop a condition or disorder. In a further embodiment, the invention relates to the prediction of a drug response, and/or prognosis of the condition or disorder, and/or severity, and/or multiple conditions or disorders, in effect any phenotypic manifestation[s] with a genetic basis found in the “reference” subject[s] prior to or after the computation of similarity measurements. In embodiments, a predictive probability value generated by a method of the invention is derived in conjunction with a further factor (e.g. genetic; environmental) which may be of interest with respect to the condition and may also play a role in the susceptibility to the condition (e.g. may be a further risk factor). Such a further factor(s) may be incorporated into the generation of the predictive probability value via for example the selection of the sources of reference allelic information or by considering further technical information relating to such sources. In embodiments, contribution of further factor(s) may be calculated separately from the calculation of predictive probability by the method of invention, and overall probability of the condition that takes into account said further factor(s) may be calculated using all known contributions.

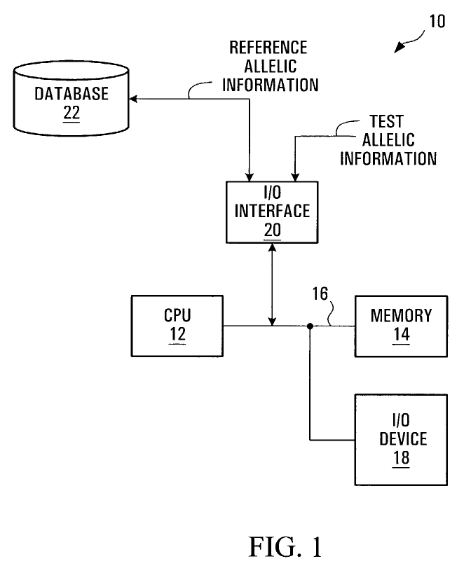

The method further relates to an apparatus capable of executing a method of the invention, an embodiment of such an apparatus being set forth in FIG. 1. FIG. 1 is an apparatus for predicting the probability that a test subject develops a polygenic condition or disorder. The apparatus 10 comprises a CPU 12 connected to a memory 14 over a data bus 16. Although the drawings show the memory 14 as a single block, the memory could also be of distributed nature. The memory holds software in the form of program data that is executed by the CPU 12 to provide the desired functionality to the apparatus 10.

An input/output device 18 connects to the data bus 16. The input/output device 18 collectively designates the means for a user to receive and/or input information such as to control the operation of the apparatus 10. Specifically, the input/output device 18 includes one or more of the following or other interfaces: display, keyboard, printer, pointing device, voice recognition system.

During the operation of the apparatus 10, the software processes data containing reference allelic information derived from at least one reference subject suffering from the condition of interest and data containing test allelic information from a test subject. The reference allelic information and the test allelic information from the test subject are input in the data bus 16 through a suitable input/output (I/O) interface 20.

To increase the accuracy of the prediction the reference allelic information is derived from at least one individual and preferably from each of a plurality of individuals all suffering from a condition of interest. The reference allelic information is stored in a database 22 that can be local to the CPU 12 or remote to the CPU 12, in which case the communication between the CPU 12 and the database 22 is effected by using any suitable communication protocol. The method for encoding the reference allelic information in the database 22 can be effected in a number of possible ways all of which are within the present inventive concept.

The test allelic information is supplied through the I/O interface 20. As in the case with the reference allelic information, the test allelic information can be encoded in a number of possible ways without departing from the spirit of the invention.

The invention further relates to a computer-readable media tangibly embodying a program of instructions executable by a computer to perform the methods of the invention.

Although various embodiments of the invention are disclosed herein, many adaptations and modifications may be made within the scope of the invention in accordance with the common general knowledge of those skilled in this art. Such modifications include the substitution of known equivalents for any aspect of the invention in order to achieve the same result in substantially the same way. Numeric ranges are inclusive of the numbers defining the range. In the claims, the word “comprising” is used as an open-ended term, substantially equivalent to the phrase “including, but not limited to”. The following examples are illustrative of various aspects of the invention, and do not limit the broad aspects of the invention as disclosed herein.

### EXAMPLES

I herein describe a novel method for improved genetic prediction of a polygenic condition or disorder, based on an individual organism as a dynamical system, rather than traditional statistical effects of particular genes in samples that blend multiple individuals.

### Example 1

Mathematical Formulation of the Invention

I consider the observation of a given condition made on an individual organism to be a discrete measurement made on the state in a map of a dynamical system (in system science the term map denotes discrete observations on a dynamical system). To address the problem of predicting the condition, I develop a novel reconstructing algorithm, based on that noted above with respect to prediction in dynamical systems (see the background section). The invention utilizes past observations, i.e. individuals that are known to be affected with a condition, to reconstruct future observations, i.e. obtain polygenic predictive information for as yet unaffected individuals. Accordingly the invention permits, for an individual organism, reconstruction of genomic contribution to a developmental polygenic condition. The invention is presented in mathematical detail as follows.

Let N denote the number of individual test genomes for whom the probability of developing a condition x is to be predicted. Let M denote the number of individual reference genomes already affected with a condition x. Let Ω_{G} be a function that quantifies Genomic Functional Similarity between two individual genomes.

First, for each individual test genome Gₙ, I define a reconstructing vector X, by way of multiple outputs of the function Ω_{G}, obtained from one-to-one comparisons made between the said test genome Gₙ and each of multiple affected reference genomes Gₐ:

Gₙ→Xₙ=[Ω_{G}(Gₙ, Gₐ₁), Ω_{G}(Gₙ, Gₐ₂), . . . Ω_{G}(Gₙ, G_{aM})] 3)

n=1 . . . N

The dimension of reconstructing vectors Xₙ, i.e. the embedding dimension, equals M, the number of affected genomes. Second, it is shown below that the maximal value of Ω_{G} for a given reconstructing vector Xₙ, denoted as maxΩ_{G}(Xₙ), can be used as an argument of the empirically derived Genomic Reconstructing Function. The Genomic Reconstructing Function reconstructs genomic contribution to a condition by quantifying probability P that individual n will develop a condition x conditional on the corresponding genome Gₙ:

P(xₙ|Gₙ)=f[maxΩ_{G}(Xₙ)] 4)

The invention disclosed herein provides predictive information as to whether a particular individual test organism will in the future attain a similar state (condition x) as another individual reference organism that has already been measured directly (affected with condition x).

### Example 2

Defining a Measure of Genomic Functional Similarity Between Individuals in Empirical Relation to the Probability of Developing a Condition

I derive Genomic Functional Similarity Ω_{G} function by developing further predictive technique based on the presence of an affected biological relative, which technique is noted in the background section. For an example of said technique, population prevalence of schizophrenia is ˜1%, and respective risks to MZ twins, offspring or siblings (first -degree relatives), and second-degree relatives of a schizophrenic individual are ˜52%, ˜10%, and ˜3% (Risch 1990a). These data quantitatively relate genomic information to the risk of disorder by way of the average proportion of genomic material which is shared identical by descent (IBD, i.e. copies of the same ancestral allele) between biological relatives. Namely, as a consequence of familial transmission, biological relatives share IBD a certain proportion of genomic material, except for monozygotic (MZ) twins, which are genetically identical. The average proportion of genetic material shared IBD decreases by half with the degree of relationship, i.e. on the average first-degree relatives share 50% of genetic material, seconddegree relatives share 25%, etc. I present further developments below, which further developments capture polygenic information to identify individuals at risk for developing a condition without such individuals having an affected biological relative.

It is of importance to realize the fact, and the unique significance therein, that the average proportion of genomic material shared among biological relatives is the sole genetic quantity evident at the hierarchical level of the genome, and widely accepted as empirically related to the risk of genetically influenced conditions including developmental polygenic conditions. As such, it is of unique significance as a fitting foundation for development of a novel genomic predictive method at the hierarchical level of the individual genome.

In order to create the Genomic Functional Similarity Ω_{G} function, I begin with eliminating certain types of genomic sequence from consideration because they do not contribute to functional genomic variation between individuals, which functional variation is of interest for predicting observed conditions. Monomorphic functional sequences can be ignored because they do not contribute to functional variation between individuals. Further, some alleles at polymorphic sequences are functional alleles because they result in altered function or expression of the gene product, and some are not functional: for example single nucleotide polymorphisms that encode the same amino-acid are typically not functional, and thus can be ignored. Further, from the ontogenetic perspective it is only relevant that a proportion of functional alleles of polymorphic sequences between individual genomes be identical by state, that is of the same allelic form. It is irrelevant whether said alleles are identical by state because they are identical by familial descent as in biological relatives. From these considerations, I herein define Genomic Functional Similarity between two individuals Ω_{G} as a proportion of functional alleles of polymorphic sequences that are identical by state. Denoting the number of functional alleles of polymorphic sequences that are identical by state by n_{f,ibs}, and the total number of functional alleles of polymorphic sequences in the genome by N_{f}, I obtain:

Ω_{G}=n_{f,ibs}/N_{f} 5)

The Genomic Reconstructing Function Ω_{G} can be restricted to a certain subset of a genome, including but not limited to an organ, tissue, cell, functionally related network, should it be indicated that condition to be predicted is influenced by said subset of a genome.

In the following example, beyond the formula 5 is developed a useful application of the same in a method for prediction of developmental polygenic disorders.

### Example 3

Individual-Oriented Method for Genomic Prediction of Polygenic Disorders

As a result of familial transmission of genetic material, Genomic Functional Similarity Ω_{G}, defined in formula 5, is on the average greater between close biological relatives than between unrelated individuals. The rationale herein is that, due to statistical nature of this observation, Genomic Functional Similarity Ω_{G} for a single pair of unrelated individuals can nevertheless be substantial for some individuals. This rationale can be exploited by computational or physico-chemical comparison of functional allelic states of polymorphic sequences present in a given unaffected individual genome, with those present in each of a plurality of individual genomes from the database of affected individuals (Template Database). This procedure will produce a series of Ω_{G} values that constitutes a reconstructing vector Xₙ, defined in formula 3. As noted in Example 1, highest Genomic Functional Similarity with any one affected individual genome for a given reconstructing vector, maxΩ_{G}(Xₙ), can be used as an argument of a Genomic Reconstructing Function defined in formula 4, the output of which is probability of the condition in an individual with a given unaffected genome. Empirical familial risks can be initially taken as quantitative benchmarks of the Genomic Reconstructing Function as illustrated in Example 4.

The predictive utility of the invention increases with the embedding dimension of the reconstructing vector, i.e. with the number of affected individual genomes in the Template Database, by way of increasing the probability of detecting individuals at elevated risk of developing a condition. The concept of dimension is important for quantifying complexity of a dynamical system, such that a high embedding dimension is required for predicting behavior of a highly complex dynamical system (Alligood et al 1997; Borovkova et al 1998). Because polygenic developmental disorders are common in the population, potential embedding dimension, i.e. number of affected individual genomes for the Template Database is on the order of millions for a large population, i.e. about 10⁶ per population of 10⁸ individuals for schizophrenia, about 10⁷ for alcohol dependence, etc. Further, most of human genetic variation occurs between individuals rather than between divergent populations, i.e. a person from Europe is often genetically more similar to a person from Africa or Asia than to another person from Europe (Paabo 2003). Accordingly, the method of invention may in a further embodiment be useful at the global international scale, by comparison of individual genomes from divergent populations: such an embodiment would provide further increase in the embedding dimension, i.e. number of affected individual genomes for the Template Database. Said number of affected individual genomes increases as new generations of affected individuals arise. In view of the use of reconstructing embedding procedure, embodiment of the invention may be termed High-dimensional Reconstruction of Polygenic Information (HRPI).

Any individual human genome can be viewed as comprised in good measure of discrete segments within chromosomes termed haplotype blocks, within which haplotype blocks genomic sequence variants tend to occur together, i.e. show linkage disequilibrium due to adjacent positions on the same chromosome (Paabo 2003; Stumpf 2002). Such linkage disequilibrium extends beyond boundaries of haplotype blocks, i.e multiple adjacent haplotypes also tend to occur together, resulting in longer segments of genomic sequence variants that tend to occur together along the chromosome (Daly et al 2001). The largest part of human genome sequence, more than 99%, is identical between any two individuals (Lander et al. 2001; Venter et al. 2001). Similarly sized major proportion of the human genome sequence exhibits features different from those found in a small remainder of said sequence indicated to represent functional sequence, and may turn out to present comparatively diminished contribution to functional genomic information. Further, functional genomic sequences that vary between individuals, which are of interest for the invention, represent only a proportion of all functional genomic sequences. Functional sequences are generally not the most polymorphic genomic sequence variants. In conjunction with the embedding dimension discussed in the previous paragraph, and with whether a certain subset of a genome is selected as specified elsewhere in this application, such features of the overall structure in the human genome will relate to the performance of the invention.

Large databases of human genomes are being created in many countries (Science 2002; Nature Genetics 2003), and the project is launched that will identify all of the functional sequences in the human genome (Science 2003). The invention disclosed herein specifies a method to use a large database resource and functional genomic information, and the performance of the invention can steadily improve as larger database and more functional genomic information became available.

### Example 4

Genomic Reconstructing Function: Approximated Example for Schizophrenia.

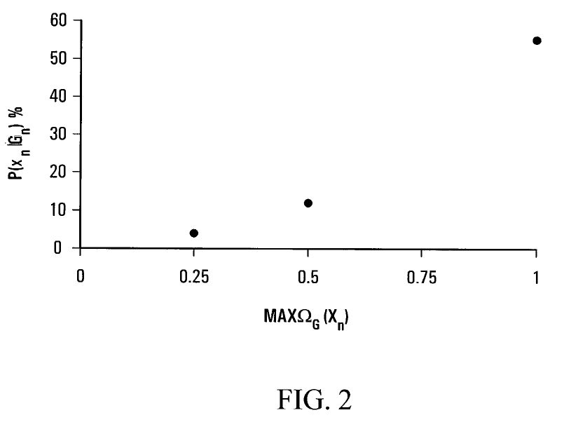

With reference to FIG. 2, the plot represents Genomic Reconstructing Function P(xₙ/Gₙ)=f[maxΩ_{G}(Xₙ)] defined in Example 1, formula 4. Approximate data points are empirical risks observed in MZ twins, 1^{st}, and 2^{nd} degree relatives of schizophrenic individuals, who share by familial descent respectively all, the average of 0.5, and the average of 0.25 of the genomic material with the schizophrenic individual. For 1^{st} degree relatives: the risk is similar for the offspring of a single schizophrenic parent who always share by descent 0.5 of genetic material with the affected, and for siblings of affected individuals without a schizophrenic parent where 0.5 represents average sharing by descent (Gottesman and Shields 1984). Children of two schizophrenic individuals are at slightly lower risk than MZ twins, ˜46% (Gottesman and Shields 1984). Identity by state of genomic sequences between biological relatives that is not due to identity by descent between biological relatives, which identity by state is not taken into account in FIG. 2, will relate to more precise quantification. The increase in probability of developing a condition for a given group of biological relatives relates to the excess of genomic material shared identical by state with the affected individual over that expected for unrelated individuals.

With reference to FIG. 2, empirical trials can provide more precise quantification of the relationship between Ω_{G} values and the probability of developing a condition for predictive purposes. Such empirical trials can for example be designed to obtain prediction in individuals who are near the age of onset for a polygenic condition, providing shorter follow-up period after which condition is expected to occur and prediction is compared with the outcome.

With reference to FIG. 2, unaffected individual genomes with higher values of maxΩ_{G}(Xₙ), that is higher Genomic Functional Similarity with any one affected individual genome, feature a higher probability of developing a condition. Accordingly, individuals with particularly high values of maxΩ_{G}(Xₙ) can be prioritized for counseling, follow-up, prevention and treatment.

Prediction for many other conditions, such as alcoholism, bipolar disorder, non-psychiatric conditions etc. can be obtained by a method of invention illustrated in FIG. 2 by way of using reference subjects affected with a condition of interest and condition-appropriate numerical data values. Because the method of invention captures polygenic information at the level of the individual, as distinct from conventional statistical effects of particular genes in samples that blend plurality of individuals, it is useful in improving prediction of polygenic conditions at the level of the individual. It is further advantageous that prediction by methods of invention can be obtained as early as at conception of the test individual, allowing for better counseling, follow-up, prevention and treatment. In addition to utilitarian embodiments presented herein, the invention provides a novel framework for studying developmental biological complexity at the level of individual organism to facilitate improved understanding of said complexity.

Although various embodiments have been illustrated, this was for the purpose of describing, but not limiting, the invention. Various modifications will become apparent to those skilled in the art and are within the scope of this invention, which is defined more particularly by the attached claims.

All references cited herein or listed in the References section below are herein incorporated by reference.

References

Alligood, K. T.; Sauer, T. D.; Yorke, J. A. (1997) Chaos: An Introduction to Dynamical Systems, Springer-Verlag, New York, N.Y.

Altschul et al. (1990), J. Mol. Biol. 215: 403-10.

Altschul et al. (1997), Nucleic Acids Res. 25: 3389-3402.

Antonarakis, S. E.; McKusick, V. A. (2000) OMIM passes the 1,000-disease-gene-mark. Nature Genetics 25: 11.

Borovkova, S.; Burton, R.; Dehling, H. (1998) Smoothing techniques for prediction of non-linear time series. In: Prochazka, A.; Uhlir, J.; Rayner, P. J. W.; Kingsbury, N. G. (eds) Signal Analysis and Prediction. Birkhauser, Boston, pp 351-362.

Brown, P. O. (1994) Genome scanning methods. Current Opinion in Genetics & Development 4: 366-373.

Craddock, N.; Jones, I. (1999) Genetics of bipolar disorder. Journal of Medical Genetics 36: 585-594.

Cossart, R.; Aronov, D.; Yuste, R. (2003) Attractor dynamics of network UP states in the neocortex. Nature 423: 283-288.

Daly, M. J.; Rioux, J. D.; Schaffner, S. F.; Hudson, T. J.; Lander, E. S. (2001) High-resolution haplotype structure in the human genome. Nature Genetics 29: 229-232.

DeLisi, L. E. (2000) Critical overview of current approaches to genetic mechanisms in schizophrenia research. Brain Research Reviews 31: 187-192.

Gottesman I. J.; Shields, J. (1984) Schizophrenia: The Epigenetic Puzzle, Cambridge University Press, Cambridge, Mass.

Henikoff and Henikoff (1992) Proc. Natl. Acad. Sci. USA 89: 10915-10919.

Kessler, R. C.; McGonagle, K. A.; Zhao, S.; Nelson, C. B.; Hughes, M.; Eshleman, S.; Wittchen, H. U.; Kendler, K. S. (1994) Lifetime and 12-month prevalence of DSM-III-R psychiatric disorders in the United States. Archives of General Psychiatry 51: 8-19.

Lander, E. S.; Linton, L. M.; Birren, B.; et al. (2001) Initial sequencing and analysis of the human genome. Nature 409: 860-921.

Levinson, D. F.; Holmans, P. A.; Laurent, C.; Mallet, Jacques.; Riley, B.; Kendler, K. S.; Pulver, A. E.; Gejman, P. V.; Sanders, A. R.; Schwab, S. G.; Wildenauer, D. B.; Owen, M. J.; Mowry, B. J. (2002) Science 298: p. 2277.

Lohmueller, K. E.; Pearce, C. L.; Pike, M.; Lander, E. S.; Hirschorn, J. N. (2003) Meta-analysis of genetic association studies supports a contribution of common variants to susceptibility to common disease. Nature Genetics 33: 177-182.

Lorenz, E. N. (1963) Deterministic Nonperiodic Flow. Journal of the Atmospheric Sciences 20: 130-141.

McIntosh, A. R.(1999) Mapping cognition to the brain through neural interactions. Memory 7: 523-548.

Mendel, G. (1865) Versuche uber Pflanzen-Hybriden. Verh. Naturfosch. Ver. Brunn, 4: 3-47. Translated in (1926) Experiments in Plant Hybridization, Harvard University Press, Massachusetts.

Nakamura et al. (1987) Science, 235: 1616-22.

Nature Genetics (2003) Bankable assets? 33: 325-326.

www.ncqa.org/sohc2002/SOHC_{—}2002_FHM.html

Needleman and Wunsch (1970) J. Mol. Biol. 48: 443

Nickerson, D. A., et al (1990) Automated DNA diagnostics using an ELISA-based oligonucleotide ligation assay. Proc Natl. Acad. Sci. USA 87:8923-8927.

Ott, J. (1999) Analysis of Human Genetic Linkage, John Hopkins University Press, Baltimore, Md.

Paabo, S. (2003). The mosaic that is our genome. Nature 421: 409-412.

Pearson and Lipman (1988) Proc. Natl. Acad. Sci. USA 85: 2444.

Risch, N. (1990a). Linkage strategies for genetically complex traits. I. Multilocus models. Am J Hum Genet 46: 222-228.

Sambrook and Russell, (2001) “Molecular Cloning: A Laboratory Manual”, Third Edition, Cold Spring Harbor Laboratory, New York.

Sambrook et al. (1989) “Molecular Cloning: A Laboratory Manual”, Second Edition, Cold Spring Harbor Laboratory, New York

Schork, N. J. (1997) Genetic of complex diseases: approaches, problems, and solutions. American Journal of Respiratory Critical Care Medicine 156: S103-S109.

Schork, N. J.; Schork, C. M. (1998). Issues and Strategies in the Genetic Analysis of Alcoholism and Related Addictive Behaviors. Alcohol 16: 71-83.

Science (2002) 298: 1158-1161.

Science (2003) 299: p. 1642.

Smith and Waterman (1981) Adv. Appl. Math 2: 482.

Stumpf, M. P. H. (2002) Haplotype diversity and the block structure of linkage disequilibrium. Trends in Genetics 18: 226-228.

Suarez, B. K.; Hampe, C. L.; Van Eerdewegh, P. (1994) Problems of Replicating Linkage Claims in Psychiatry. In Genetic Approaches to Mental Disorders, eds ES Gershon, CR Cloninger. Washington, D.C. American Psychiatric Press. Pp 23-46.

Takens, F. (1981) Detecting strange attractors in turbulence. In: Dold, A.; Eckmann, B. (eds) Lecture Notes in Mathematics. Springer-Verlag, New York, N.Y., pp 366-381.

Venter, J. C.; Adams, M. D.; Myers, E. W.; et al. (2001) The sequence of the human genome. Science 291: 1304-1351.

Weiss, K. M.; Terwilliger, J. D. (2000) How many diseases does it take to map a gene with SNPs? Nature Genetics 26: 151-156.

I claim:

1. An apparatus for predicting the probability that a test subject develops a condition, said apparatus comprising:
a) an input for receiving test data containing allelic information derived from the test subject;
b) a database containing a plurality of reference data blocks, each data block containing allelic information derived from a reference subject suffering from the condition;
c) a processing unit for:
i) comparing the test data with a plurality reference data blocks to derive respective similarity measurements;
ii) deriving a predictive probability value from the similarity measurements;
d) an output to release data containing the predictive probability value.

2. The apparatus of claim 1, wherein the allelic information comprises single nucleotide polymorphisms (SNPs).

3. The apparatus of claim 1, wherein the allelic information is obtained from an entire genome.

4. The apparatus of claim 1, wherein the allelic information is derived from a subset of a genome.

5. The apparatus of claim 1, wherein said allelic information is obtained by a genotyping method based on a technique selected from the group consisting of:
a) nucleotide sequencing;
b) minisatellite marker analysis;
c) microsatellite marker analysis;
d) hybridization of allele-specific probes;
e) restriction fragment length polymorphism (RFLP) analysis; and
f) any combination of (a) to (e).

6. The apparatus of claim 1, wherein the allelic information is obtained from a nucleic acid molecule selected from the group consisting of DNA and RNA.

7. The apparatus of claim 6, wherein the DNA is selected from the group consisting of genomic DNA and cDNA.

8. The apparatus of claim 1, wherein the allelic information comprises gene expression data.

9. The apparatus of claim 1, wherein the allelic information is obtained from a source of information selected from the group consisting of:
(a) protein structure;
(b) protein function; and
(c) both (a) and (b).

10. The apparatus of claim 1, wherein the allelic information is obtained from a part of the test subject and the reference subject.

11. The apparatus of claim 10, wherein the part is selected from the group consisting of a tissue, cell type, and organ.

12. A method for predicting the probability that a test subject develops a condition, said method comprising:
a) providing test data containing allelic information derived from the test subject;
b) providing a database containing a plurality of reference data blocks, each data block containing allelic information derived from a reference subject suffering from the condition;
c) comparing the test data with each reference data block to derive a plurality of respective similarity measurements; and
d) deriving a predictive probability value from the similarity measurements;
wherein the predictive probability value is used for predicting the probability that a test subject develops the condition.

13. The method of claim 12, wherein the allelic information comprises single nucleotide polymorphisms (SNPs).

14. The method of claim 12, wherein the allelic information is obtained from an entire genome.

15. The method of claim 12, wherein the allelic information is derived from a subset of a genome.

16. The method of claim 12, wherein said allelic information is obtained by a genotyping method based on a technique selected from the group consisting of:
(a) nucleotide sequencing;
(b) minisatellite marker analysis;
(c) microsatellite marker analysis;
(d) hybridization of allele-specific probes;
(e) restriction fragment length polymorphism (RFLP) analysis; and
(f) any combination of (a) to (e).

17. The method of claim 12, wherein the allelic information is obtained from a nucleic acid molecule selected from the group consisting of DNA and RNA.

18. The method of claim 17, wherein the DNA is selected from the group consisting of genomic DNA and cDNA.

19. The method of claim 12, wherein the allelic information comprises gene expression data.

20. The method of claim 12, wherein the allelic information is obtained from a source of information selected from the group consisting of:
(a) protein structure;
(b) protein function; and
(c) both (a) and (b).

21. The method of claim 12, wherein the allelic information is obtained from a part of the test subject and the reference subject.

22. The method of claim 21, wherein the part is selected from the group consisting of a tissue, cell type, and organ.

23. Computer-readable media tangibly embodying a program of instructions executable by a computer to perform a method for predicting the probability that a test subject develops a condition, the method comprising:
a) providing test data containing allelic information derived from the test subject;
b) providing a database containing a plurality of reference data blocks, each data block containing allelic information derived from a reference subject suffering from the condition;
c) comparing the test data with each of a plurality of reference data block to derive a plurality of respective similarity measurements; and
d) deriving a predictive probability value from the similarity measurements;
wherein the predictive probability value is used for predicting the probability that a test subject develops the condition.

24. The computer-readable media of claim 23, wherein the allelic information comprises single nucleotide polymorphisms (SNPs).

25. The computer-readable media of claim 23, wherein the allelic information is obtained from an entire genome.

26. The computer-readable media of claim 23, wherein the allelic information is derived from a subset of a genome.

27. The computer-readable media of claim 23, wherein said allelic information is obtained by a genotyping method based on a technique selected from the group consisting of:
(a) nucleotide sequencing;
(b) minisatellite marker analysis;
(c) microsatellite marker analysis;
(d) hybridization of allele-specific probes;
(e) restriction fragment length polymorphism (RFLP) analysis; and
(f) any combination of (a) to (e).

28. The computer-readable media of claim 23, wherein the allelic information is obtained from a nucleic acid molecule selected from the group consisting of DNA and RNA.

29. The computer-readable media of claim 28, wherein the DNA is selected from the group consisting of genomic DNA and cDNA.

30. The computer-readable media of claim 23, wherein the allelic information comprises gene expression data.

31. The computer-readable media of claim 23, wherein the allelic information is obtained from a source of information selected from the group consisting of:
(a) protein structure;
(b) protein function; and
(c) both (a) and (b).

32. The computer-readable media of claim 23, wherein the allelic information is obtained from a part of the test subject and the reference subject.

33. The computer-readable media of claim 32, wherein the part is selected from the group consisting of a tissue, cell type, and organ.

34. An apparatus for predicting the probability that a test subject develops a condition, said apparatus comprising:
a) an input for receiving a plurality of similarity measurements, wherein said similarity measurements are obtained by respective comparisons of a test genomic sequence from a test subject with each of a plurality of reference genomic sequences from a respective plurality of reference subjects suffering from the condition, by a comparison method comprising a physico-chemical reaction between said test and reference genomic sequences;
b) a processing unit for deriving a predictive probability value from the similarity measurements; and
c) an output to release data containing the predictive probability value.

35. The apparatus of claim 34, wherein the comparison method is Genomic Mismatch Scanning.

36. The apparatus of claim 34, wherein the genomic sequence is derived from an entire genome.

37. The apparatus of claim 34, wherein the genomic sequence is derived from a subset of a genome.

38. The apparatus of claim 34, wherein the genomic sequence is obtained from a part of the test subject and the reference subject.

39. The apparatus of claim 38, wherein the part is selected from the group consisting of a tissue, cell type, and organ.

40. A method for predicting the probability that a test subject develops a condition, said method comprising:
a) comparing a test genomic sequence from a test subject with each of a plurality of reference genomic sequences from a respective plurality of reference subjects suffering from the condition, by a comparison method comprising a physico-chemical reaction between said test and reference genomic sequences, to obtain a plurality of respective similarity measurements;
b) deriving a predictive probability value from the similarity measurements;
wherein the predictive probability value is used for predicting the probability that a test subject develops the condition.

41. The method of claim 40, wherein the comparison method is Genomic Mismatch Scanning.

42. The method of claim 40, wherein the genomic sequence is derived from an entire genome.

43. The method of claim 40, wherein the genomic sequence is derived from a subset of a genome.

44. The method of claim 40, wherein the genomic sequence is obtained from a part of the test subject and the reference subject.

45. The method of claim 44, wherein the part is selected from the group consisting of a tissue, cell type, and organ.

46. Computer-readable media tangibly embodying a program of instructions executable by a computer to perform a method for predicting the probability that a test subject develops a condition, the method comprising:
a) comparing a test genomic sequence from a test subject with each of a plurality of reference genomic sequences from a respective plurality of reference subjects suffering from the condition, by a comparison method comprising a physico-chemical reaction between said test and reference genomic sequences, to obtain a plurality of respective similarity measurements;
b) deriving a predictive probability value from the similarity measurements;
wherein the predictive probability value is used for predicting the probability that a test subject develops the condition.

47. The computer-readable media of claim 46, wherein the comparison method is Genomic Mismatch Scanning.

48. The computer-readable media of claim 46, wherein the genomic sequence is derived from an entire genome.

49. The computer-readable media of claim 46, wherein the genomic sequence is derived from a subset of a genome.

50. The computer-readable media of claim 46, wherein the genomic sequence is obtained from a part of the test subject and the reference subject.

51. The computer-readable media of claim 50, wherein the part is selected from the group consisting of a tissue, cell type, and organ.
